(19) United States
(12) Patent Application Publication
(10) Pub. No.: US 2023/0101326 A1
(43) Pub. Date: Mar. 30, 2023

(54) CORE-SHELL PARTICLES WITH ORGANIC POLYMER CORES

(71) Applicant: Waters Technologies Corporation, Milford, MA (US)

(72) Inventors: MingCheng Xu, Lexington, MA (US); Darryl W. Brousmiche, Grafton, MA (US); Daniel P. Walsh, Danvers, MA (US); Nicole L. Lawrence, Stafford Springs, CT (US); Kevin D. Wyndham, Upton, MA (US)

(73) Assignee: Waters Technologies Corporation, Milford, MA (US)

(21) Appl. No.: 17/896,938

(22) Filed: Aug. 26, 2022

Related U.S. Application Data
(60) Provisional application No. 63/237,174, filed on Aug. 26, 2021.

(51) Int. Cl. B01J 13/14; C08L 83/04; C08L 39/06

(52) U.S. Cl. CPC B01J 13/14; C08L 83/04; C08L 39/06; C08L 2207/53

(57) ABSTRACT

In various embodiments, the present disclosure pertains to core-shell particles that comprise a porous hybrid organic-inorganic shell disposed on a surface-modified non-porous polymer particle core. In some embodiments, the present disclosure pertains to chromatographic separation devices that comprise such core-shell particles. In some embodiments, the present disclosure pertains to chromatographic methods that comprise: (a) loading a sample onto a chromatographic column comprising such core-shell particles and (b) flowing a mobile phase through the column.

### CROSS-REFERENCE TO RELATED APPLICATION

This application claims priority and benefit to U.S. Provisional Patent Application No. 63/237,174, filed on Aug. 26, 2021, and entitled “CORE-SHELL PARTICLES WITH ORGANIC POLYMER CORES”, the contents of which is incorporated herein by reference in its entirety.

### BACKGROUND

Superficially porous particles (also called pellicular, fused-core, or core-shell particles) comprise a core-shell structure based on a non-porous core and a porous shell. Such particles were routinely used as chromatographic sorbents in the 1970's. These earlier superficially porous materials had thin porous layers, prepared from the adsorption of silica sols to the surface of ill-defined, polydisperse, nonporous silica cores (>20 μm). Modern, commercially available superficially porous materials typically use smaller (e.g., <2 μm) particles. Superficially porous particles have various advantages over fully porous particles, including improvements in mass transfer, increased efficiencies, and reduced back pressures.

Currently, the dominant superficially porous chromatographic materials comprise a core-shell structure based on a non-porous core and a porous shell and are made from silica or organic/inorganic hybrid materials. The cores for those type of materials are all based on inorganic or organic/inorganic hybrid particles. Even though the stability against high or low pH is improved by coating the peripheral surface of the core and the pore surface of the shell with organic/inorganic hybrid, such particles are not ideal in some chromatographic applications where a high concentration of base or acid is used, such as separation of ionizable compounds and separation of biomolecules.

There is a continuing need for further superficially porous chromatographic particles, which have good mechanical stability, a narrow particle size distribution, improved chemical stability with high and low pH mobile phases (e.g., both core and shell tolerating a broad range of pH from 1 to 11), and broad flexibility with regard to pore diameter selection.

### SUMMARY

In various embodiments, the present disclosure pertains to core-shell particles that comprise a porous hybrid organic-inorganic shell disposed on a surface-modified non-porous organic polymer core. That is, embodiments of the present disclosure are directed to a core-shell particle including a non-porous polymer (e.g., organic material) particle core having a modified surface and a porous hybrid organic-inorganic shell layer in contact with the modified surface. In some embodiments, the modified surface is a silyl-modified surface comprising a first functionality (i.e., a reactive silane) and a second functionality (i.e., an organic polymerizable group). In certain embodiments, the modified surface is covalently and/or electrostatically bonded to the porous hybrid organic-inorganic shell layer.

In some embodiments, the core-shell particles have a particle size ranging from 1 μm to 14 μm.

In some embodiments, which pertain to the any of the above embodiments, the non-porous polymer (i.e., organic) particle core comprises an organic polymer having a polymer backbone that contains C—C covalent bonds, C—O covalent bonds, C—N covalent bonds, O—N covalent bonds, or a combination thereof.

In some embodiments, which pertain to the any of the above embodiments, the non-porous polymer particle core comprises an organic polymer having a polymer backbone that contains C—C covalent bonds.

In some embodiments, which pertain to the any of the above embodiments, the non-porous polymer particle core comprises an organic polymer that is formed from radical polymerization, condensation polymerization, ring opening polymerization, or cationic-anionic polymerization.

In some embodiments, which pertain to the any of the above embodiments, the non-porous polymer particle core comprises an organic polymer that comprises hydrophobic organic monomer residues, hydrophilic organic monomer residues, or a mixture of hydrophilic organic monomer residues and hydrophobic organic monomer residues.

In some embodiments, which pertain to the any of the above embodiments, the non-porous polymer particle core comprises polyfunctional monomer residues.

In some embodiments, which pertain to the any of the above embodiments, the non-porous polymer particle core comprises polyfunctional monomer residues and monofunctional monomer residues. In some cases, the non-porous polymer particle core may comprise a central core region and an outer core region surrounding the central core region, and a concentration of the monofunctional monomer residues in the central core region may be greater than in the outer core region. In some cases, the non-porous polymer particle core may comprise a central core region and an outer core region surrounding the central core region, and a concentration of the monofunctional monomer residues in the central core region may be lesser than in the outer core region

In some embodiments, which pertain to the any of the above embodiments, the non-porous polymer particle core comprises divinyl benzene residues, styrene residues, acrylate residues, methacrylate residues, acrylonitrile residues, acrylamide residues, and combinations thereof.

In some embodiments, which pertain to the any of the above embodiments, the modified surface of the non-porous polymer particle core comprises a crosslinked polymer layer that is disposed on the non-porous polymer core. In some embodiments, the modified surface of the non-porous polymer particle core comprises polymer chains that are grafted on the non-porous polymer particle core.

In some embodiments, which pertain to the any of the above embodiments, the modified surface comprises a monomer residue that is covalently bonded to the porous hybrid organic-inorganic shell layer. For example, the monomer residue may comprise an organosilane monomer residue, an organotitanium monomer residue, or an organozirconium monomer residue.

In some embodiments, which pertain to the any of the above embodiments, the modified surface comprises a monomer residue that is electrostatically bonded to the hybrid organic-inorganic porous shell. For example, the monomer residue may comprise an amide monomer residue or an amine monomer residue.

In some embodiments, which pertain to the any of the above embodiments, the modified surface includes a thickness that ranges from 1 to 300 nm.

In some embodiments, which pertain to above embodiments including the silyl-modified surface, the reactive silane comprises an alkoxy. In certain embodiments, the organic polymerizable group can comprise a vinyl. In some embodiments, the silyl modified surface of the non-porous polymer particle is modified with at least one of N-Vinylpyrrolidone, N-Vinylcaprolactam, N,N— Dimethylvinylbenzylamine, Methacryloxypropyltrimethoxylsilane, or p-Styryltrimethoxysilane.

In some embodiments, which pertain to the any of the above embodiments, the porous hybrid organic-inorganic shell layer has a pore size ranging from 20 Å to 2000 Å.

In some embodiments, which pertain to the any of the above embodiments, the porous hybrid organic-inorganic shell layer ranges 0.1 to 4 microns in thickness.

In some embodiments, which pertain to the any of the above embodiments, a ratio of a diameter of the non-porous polymer particle core to an overall diameter of the core-shell particle is in the range from 0.4/1 to 0.99/1.

In some embodiments, which pertain to the any of the above embodiments, the porous hybrid organic-inorganic shell layer has a pore volume greater than or equal to 0.05 cc/g.

In some embodiments, which pertain to the any of the above embodiments, the porous hybrid organic-inorganic shell layer comprises a network of (a) silicon atoms having four silicon-oxygen bonds and (b) silicon atoms having one or more silicon-oxygen bonds and one or more silicon-carbon bonds.

In some embodiments, which pertain to the any of the above embodiments, the porous hybrid organic-inorganic shell layer comprises a substituted or unsubstituted C₁-C₄ alkylene, C₁-C₄ alkenylene, C₁-C₄ alkynylene or C₁-C₄ arylene moiety bridging two or more silicon atoms.

In some embodiments, which pertain to the any of the above embodiments, the porous hybrid organic-inorganic shell layer is formed by hydrolytically condensing (a) one or more silane compounds of the formula SiZ₁Z₂Z₃Z₄, where Z₁, Z₂, Z₃ and Z₄ are independently selected from C₁, Br, I, C₁-C₄ alkoxy, and C₁-C₄ alkylamino and (b) one or more silane compounds of the formula SiZ₄Z₅Z₆—R— SiZ₇Z₈Z₉, where Z₄, Z₅ and Z₆ are independently selected from C₁, Br, I, C₁-C₄ alkoxy, C₁-C₄ alkylamino, and C₁-C₄ alkyl, although at most two of Z₄, Z₅ and Z₆ can be C₁-C₄ alkyl, where Z₇, Z₈ and Z₉ are independently selected from C₁, Br, I, C₁-C₄ alkoxy, C₁-C₄ alkylamino, and C₁-C₄ alkyl, although at most two of Z₇, Z₈ and Z₉ can be C₁-C₄ alkyl, and where R is substituted or unsubstituted C₁-C₄ alkylene, C₁-C₄ alkenylene, C₁-C₄ alkynylene or C₁-C₄ arylene.

In other aspects, the present disclosure pertains to chromatographic separation devices that comprise the core-shell particles of any of the above embodiments.

In still other aspects, the present disclosure pertains to chromatographic method that comprise: (a) loading a sample onto a chromatographic column comprising the core-shell particles of any of the above embodiments and (b) flowing a mobile phase through the column.

### BRIEF DESCRIPTION OF THE DRAWINGS

FIG. 1 is a schematic illustration of a nonporous organic polymer core formation step, in accordance with an embodiment of the present disclosure.

FIG. 2 is a schematic illustration of a nonporous organic polymer core growth step, in accordance with an embodiment of the present disclosure.

FIG. 3 is a schematic illustration of a surface modification step, in accordance with an embodiment of the present disclosure.

FIG. 4A is a schematic illustration of a shell forming step, in accordance with an embodiment of the present disclosure.

FIG. 4B is a schematic illustration of a residue on the surface of a nonporous organic polymer core, in accordance with an embodiment of the present disclosure.

FIG. 5A is a scanning electron microscope photograph of whole particles formed in accordance with Example 4 of the present disclosure.

FIG. 5B is a scanning electron microscope photograph of particle cross-sections of the whole particles formed in accordance with Example 4 of the present disclosure.

FIG. 5C illustrates nitrogen BET pore area vs. pore diameter, in accordance with various embodiments of the present disclosure.

FIG. 6A is an electron microscope photograph of the whole silane primed particle (prior to formation of a porous shell) in accordance with Example 5 of the present disclosure.

FIG. 6B is an electron micrograph photograph of a whole particle (i.e., after formation of a porous shell on the silane primed particle shown in FIG. 6A).

FIG. 6C is a higher magnification photograph of a portion of the whole particle of FIG. 6B.

FIG. 7A is a scanning electron microscope photograph of whole particles formed in accordance with Example 6 of the present disclosure.

FIG. 7B is a scanning electron microscope photograph of particle cross-sections of the whole particles formed in accordance with Example 6 of the present disclosure.

FIG. 7C illustrates nitrogen BET pore area vs. pore diameter, in accordance with various embodiments of the present disclosure.

FIG. 8A is a scanning electron microscope photograph of whole particles formed in accordance with Example 7 of the present disclosure.

FIG. 8B is a scanning electron microscope photograph of particle cross-sections of the whole particles formed in accordance with Example 7 of the present disclosure.

FIG. 8C illustrates nitrogen BET pore area vs. pore diameter, in accordance with various embodiments of the present disclosure.

FIG. 9A is an electron microscope photograph of the whole silane primed particle (prior to formation of a porous shell) in accordance with Example 12 of the present disclosure.

FIG. 9B is an electron microscope photograph of a plurality of whole silane primed particles (prior to formation of a porous shell) in accordance with Example 12 of the present disclosure.

FIG. 9C is an electron microscope photograph of a whole particle (i.e., after formation of a porous shell on the silane primed particle shown in FIG. 9A).

FIG. 9D is an electron microscope photograph of a plurality of whole particles (i.e., after formation of a porous shell on the silane primed particle shown in FIG. 9A).

### DETAILED DESCRIPTION

The present disclosure pertains to core-shell particles (also referred to herein as superficially porous particles) that comprise a porous hybrid organic-inorganic shell disposed on a surface-modified non-porous organic polymer core. That is, embodiments of the present disclosure are directed to a core-shell particle including a non-porous polymer (e.g., organic material) particle core having a modified surface and a porous hybrid organic-inorganic shell layer in contact with the modified surface. In some embodiments, the modified surface is a silyl-modified surface comprising a first functionality (i.e., a reactive silane) and a second functionality (i.e., an organic polymerizable group). In certain embodiments, the modified surface is covalently and/or electrostatically bonded to the porous hybrid organic-inorganic shell layer.

The core-shell particles of the present disclosure are typically spherical. The core-shell particles of the present disclosure typically range from 1 to 14 microns in diameter, more typically, from 1 to 6 microns in diameter. Particle diameter is measured herein by Coulter Counter ((Beckman Coulter, Multisizer 4e Coulter Counter, Brea, Calif., USA) by dispersing a sample in methanol containing 5% lithium chloride. A greater than 70,000 particle count is run using a 30 μm aperture in the volume mode for each sample. Using the Coulter principle, volumes of particles are converted to diameter, where a particle diameter is the equivalent spherical diameter, which is the diameter of a sphere whose volume is identical to that of the particle. Particle diameter measured as the 50% cumulative diameter of the volume based particle size distribution

The core-shell particles of the present disclosure have good stability, even at pH's greater than 12 and less than 1, in some embodiments.

The core-shell particles of the present disclosure are also typically narrowly dispersed in particle size. As defined herein, a collection of particles is “narrowly dispersed in particle size” when a ratio of 90% cumulative volume diameter divided by the 10% cumulative volume diameter is less than 1.4 when measured by Beckman Coulter, Multisizer 4e Coulter Counter.

The core-shell particles of the present disclosure can be of widely ranging porosity. For example, the core-shell particles may have average pore diameters that range from 20 or less to 1000 Angstroms or more, for example ranging from 20 to 50 to 70 to 100 to 150 to 200 to 250 to 300 to 400 to 500 to 750 to 1000 Angstroms.

Pore sizes are measured by conventional porosimetry methods. For sub-500 Angstrom pores, the average pore diameter (APD) can be measured using the multipoint N₂ sorption method (Micromeritics ASAP 2400; Micromeritics Instruments Inc., Norcross, Ga.), with APD being calculated from the desorption leg of the isotherm using the BJH method as is known in the art. Hg porosimetry may be used for pores that are 400 Angstrom or greater, as is known in the art.

The nonporous organic polymer core and porous hybrid organic-inorganic shell will now be discussed in more detail.

### Nonporous Polymer Core.

The polymer particle cores for use in the present disclosure comprise at least one organic polymer. The organic polymer cores typically contain more than 95% organic polymer, more typically more than 97.5% organic polymer, even more typically more than 99% organic polymer.

The polymer particle cores are nonporous, which is defined herein to mean that the polymer particle cores have a pore volume that is less than 0.1 cc/g. Preferably, organic polymer cores have a pore volume that is less than 0.05 cc/g, and preferably less than 0.02 cc/g, in some embodiments. Pore volume is determined using methods known in the art based on multipoint nitrogen sorption experiments (Micromeritics ASAP 2400; Micromeritics Instruments Inc., Norcross, Ga.).

The polymer cores typically range, for example, from 1 to 10 microns in diameter, more typically, from 1 to 5 microns in diameter. The polymer cores are typically narrowly distributed in particle size.

Elementally, polymer particle cores for use in the present disclosure include those that are composed of carbon and hydrogen, those composed of carbon, hydrogen and oxygen, those composed of carbon, hydrogen and nitrogen, and those composed of carbon, hydrogen, nitrogen and oxygen. The backbones of the organic polymer chains forming the polymer cores may contain C—C, C—O, C—N and/or O—N covalent bonds. In some embodiments (e.g., in the case of a polymer formed by radical polymerization of vinyl groups), the backbone of the at least one organic polymer chains may contain only C—C covalent bonds.

As noted above polymer cores for use in the present disclosure comprise at least one organic polymer. The at least one organic polymer comprises residues of one or more organic monomers. The one or more organic monomers residues forming the least one organic polymer may be selected from residues of hydrophobic organic monomers, residues of hydrophilic organic monomers, or a mixture of residues of hydrophobic organic monomers and residues of hydrophilic organic monomers.

Hydrophobic organic monomers may be selected, for example, from a C₂-C₁₈ olefin monomer and/or a monomer comprising a C₆-C₁₈ monocyclic or multicyclic carbocyclic group (e.g., a phenyl group, a phenylene group, naphthalene group, etc.). Specific examples of hydrophobic organic monomers include, for example, monofunctional and multifunctional aromatic monomers such as styrene, alkyl substituted styrene, halo substituted styrene, divinylbenzene, and vinylbenzyl chloride, monofunctional and multifunctional olefin monomers such as ethylene, propylene or butylene, monofunctional and multifunctional fluorinated monomers such as fluoroethylene, 1,1- (difluoroethylene), tetrafluoroethylene, chlorotrifluoroethylene, hexafluoropropylene, perfluoropropylvinylether, or perfluoromethylvinylether, monofunctional or multifunctional acrylate monomers having a higher alkyl or carbocyclic groups, for example, monofunctional or multifunctional acrylate monomers having a C₆-C₁₈ alkyl, alkenyl or alkynyl group or a C₆-C₁₈ saturated, unsaturated or aromatic carbocyclic group, monofunctional or multifunctional methacrylate monomers having a higher alkyl or carbocyclic group, for example, monofunctional or multifunctional methacrylate monomers having a C₆-C₁₈ alkyl, alkenyl or alkynyl group or a C₆-C₁₈ saturated, unsaturated or aromatic carbocyclic group, among others.

Hydrophilic organic monomers may be selected, for example, from monofunctional or multifunctional organic monomers having an amide group, monofunctional or multifunctional organic monomers having an ester group, monofunctional or multifunctional organic monomers having a carbonate group, monofunctional or multifunctional organic monomers having a carbamate group, monofunctional or multifunctional organic monomers having a urea group, monofunctional or multifunctional organic monomers having a hydroxyl group, and monofunctional or multifunctional organic monomers having a nitrogen-containing heterocyclic group, among other possibilities. Specific examples of hydrophilic organic monomers include, for example, vinyl pyridine, N-vinylpyrrolidone, N-vinyl-piperidone, N-vinyl caprolactam, lower alkyl acrylates (e.g., methyl acrylate, ethyl acrylate, etc.), lower alkyl methacrylates (e.g., methyl methacrylate, ethyl methacrylate, etc.), vinyl acetate, acrylamide or methacrylamide monomers, hydroxypolyethoxy allyl ether monomers, ethoxy ethyl methacrylate, glycidyl methacrylate, ethylene glycol dimethacrylate, methylene bisacrylamide, allyl methacrylate, or diallyl maleate.

In various embodiments, the nonporous polymer cores comprise residues of multifunctional hydrophobic organic monomers such as divinylbenzene and/or multifunctional hydrophilic organic monomers, such as ethylene glycol dimethacrylate, methylene bisacrylamide or allyl methacrylate, in order to provide crosslinks in the organic copolymer. In certain embodiments, DVB 80 may be employed, which is an organic monomer mixture that comprises divinylbenzene (80%) as well as a mixture of ethyl-styrene isomers, diethylbenzene, and can include other isomers as well.

In various embodiments, the polymer core may comprise residues of only multifunctional organic monomers. In various embodiments, the polymer may comprise residues of both multifunctional organic monomers and monofunctional organic monomers.

The present inventors have found that, in some embodiments, the porosity of a material formed from an polymer containing multifunctional organic monomer residues can be reduced by adding monofunctional organic monomer residues to the polymer, or that the porosity of a material formed from a polymer containing multifunctional organic monomer residues and monofunctional organic monomer residues can be reduced by increasing an amount of the monofunctional organic monomer residues relative to the multifunctional organic monomer residues in the polymer. For example, it has been found that polymer particle cores formed from DVDB 80 (which are formed from organic polymers containing 80% multifunctional divinyl benzene monomer residues and monofunctional ethylstyrene monomer residues as explained above) have a porosity of about 0.015 cc/g, whereas organic polymer cores formed from DVDB 80 and styrene (which contain multifunctional divinyl benzene monomer residues, monofunctional ethylstyrene monomer residues, and additional monofunctional styrene monomer residues) have a porosity of less than 0.007 cc/g.

In some embodiments, polymer particle cores are created in which a central region of the cores is formed from an organic copolymer containing multifunctional organic monomer residues and monofunctional organic monomer residues and an outer region of the cores is formed from an organic homopolymer containing only multifunctional organic monomer residues. In some embodiments, organic polymer cores are created in which a central region of the cores is formed from an organic copolymer containing multifunctional organic monomer residues and monofunctional organic monomer residues and an outer region of the cores is also formed from an organic copolymer containing multifunctional organic monomer residues and monofunctional organic monomer residues, but wherein a molar ratio of the multifunctional organic monomer residues relative to the monofunctional organic monomer residues is increased in the outer core region relative to the central core region. In a particular example, organic polymer cores are created in which a central region of the cores is formed from DVB and styrene and an outer region of the cores is formed from DVB. In other embodiment, the molar ratio of the multifunctional organic monomer residues relative to the monofunctional organic monomer residues is decreased in the outer core region relative to the central core region.

In various embodiments, an entire polymer particle core may be formed from an organic polymer that comprises residues of multifunctional organic monomers but does not contain resides of monofunctional organic monomers. In various embodiments, an entire polymer particle core may be formed from an organic polymer that comprises residues of both multifunctional organic monomers and monofunctional organic monomers.

The polymers forming the polymer particle cores can be prepared via a number of processes and mechanisms including, but not limited to, chain addition and step condensation processes, radical, anionic, cationic, ring-opening, group transfer, metathesis, and photochemical mechanisms. In particularly beneficial embodiments, the porous polymer particle cores are prepared via free radical polymerization.

The polymer particle cores of the present disclosure can be prepared in some embodiments by a dispersion polymerization process in which a homogeneous solution is formed, wherein monomers, initiator and stabilizer are combined in a solvent or solvent mixture. As polymerization proceeds, the initially formed polymers precipitate from the homogeneous solution to form nuclei. The nuclei that form still bear reactive sites such as radicals which allow them to keep growing by continuous capture and incorporation of monomers and/or oligomers from the solution.

In an exemplary process based on radical polymerization, one or more solvents and one or more stabilizers are purged with nitrogen to remove dissolved oxygen. Then, one or more monomers, including at least one multifunctional monomer, and a radical polymerization initiator are added. Radical polymerization is initiated by raising the temperature for several hours, typically under agitation. Based on the desired particle diameter, further radical polymerization initiator and further monomer may be added to the reaction mixture to allow the particle further to grow to the desired size. After reaction, the particles may be thoroughly washed and dried under vacuum.

Any radical initiator that is compatible with the organic phase may be used, either alone or in a mixture of such radical initiators. In particular embodiments, the radical initiators are capable of being heat activated or photoactivated. In specific embodiments, the radical initiator is a peroxide, a peroxyacetate, a persulfate, an azo initiator or a mixture thereof.

Where the initiator is a thermal initiator, the resulting solution may then be heated to an elevated temperature under agitation to activate the thermal initiator(s) and maintained at elevated temperature until polymerization is complete. Where the initiator is a photoinitiator, the resulting solution may then be illuminated under agitation with light having a suitable wavelength to activate the photoinitiator(s) and maintained until polymerization is complete. Suitable organic monomers for use in the organic phase are described above.

Solvent systems for the formation of polymer particle cores include methanol, ethanol, isopropanol, 2-methoxyehanol, water, acetonitrile, p-xylene, and toluene.

Stabilizers that can be employed for the formation of polymer particle cores include, for example, polyvinylpyrrolidone (PVP), non-ionic surfactants including alkylphenol ethoxylates (e.g., Triton™ N-57, available from Dow Chemical), polyvinyl alcohol (PVA) such as Selvol™ Polyvinyl Alcohol solution, available from Sekisui Special Chemicals), modified celluloses, including alkyl-modified celluloses such as methyl celluloses (e.g., Methocel™, available from DuPont) and hydrophobically modified celluloses hydroxyethylcellulose stabilizers such as Natrosol™ cetyl modified hydroxyethylcellulose (available from Ashland), and ionic surfactants including sodium alkyl sulfates such as sodium dodecyl sulfate (SDS) and sodium oleyl sulfate, among others.

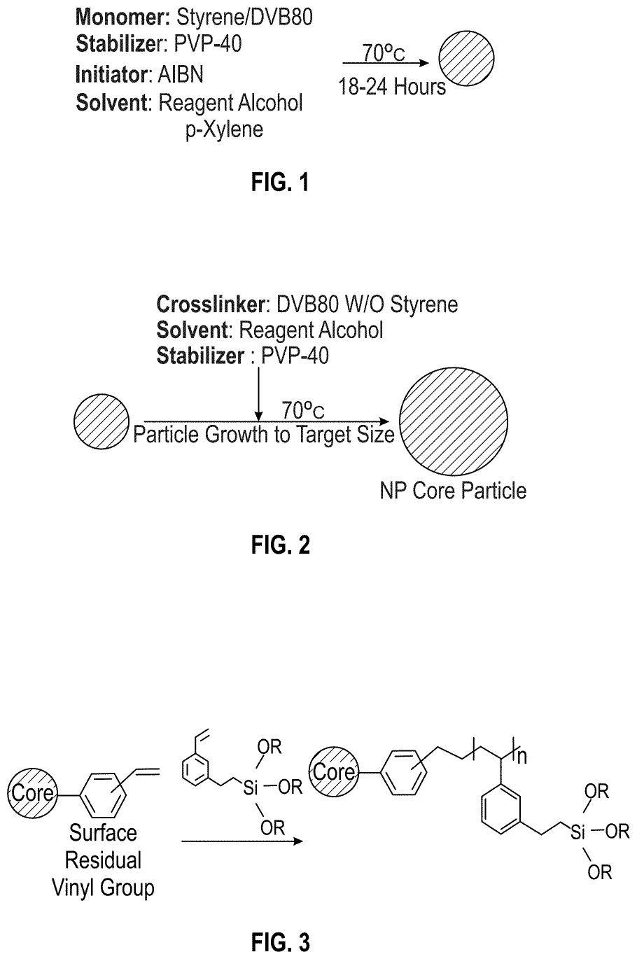

A particular embodiment of nonporous polymer particle core formation, in which the monomer is a combination of DVB and styrene, the initiator is 2,2′-Azobis(2-methylpropionitrile) (AIBN), the solvent system is a combination of reagent alcohol and p-xylene, and the stabilizer is polyvinyl pyrrolidone (PVP 40), is schematically illustrated in FIG. 1.

Once formed, the organic polymer cores may contain surface moieties from which further polymerization can proceed. For example, nonporous polymer particle cores formed from free radical polymerization commonly contain residual radical-polymerizable unsaturated surface moieties (e.g., ethylenyl moieties, vinyl moieties, methacryloxy moieties, or acryloxy moieties, etc.), from which further core growth can proceed. Such further polymerization may be used to increase the size of a given batch of polymer particle cores by adding an additional thickness of non-porous organic polymer to previously formed non-porous polymer particle cores.

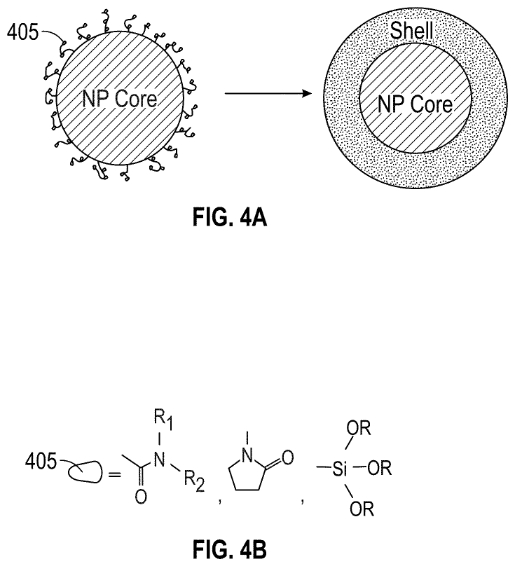

A particular embodiment of nonporous polymer particle core growth, in which the monomer is DVB, the solvent is reagent alcohol, and the stabilizer is polyvinyl pyrrolidone (PVP 40), is schematically illustrated in FIG. 2.

### Surface-Modified Non-Porous Polymer Core.

In some embodiments, the application is directed to a non-porous polymer particle with a modified surface. In some embodiments, a porous hybrid organic-inorganic shell layer is formed on the modified surface to create a core-shell particle. The modified surface of the non-porous polymer particle, in some embodiments, can form a covalent or electrostatic bond with a subsequently applied porous hybrid organic-inorganic shell layer. In certain embodiments, the modified surface of the non-porous polymer core is a silyl modified surface. The silyl modified surface includes a first functionality and a second functionality. For example, the first functionality is a reactive silane (e.g., alkoxy) and the second functionality is an organic polymerizable group (e.g., vinyl).

In some embodiments, the modified surface of the non-porous polymer particle core can have a thickness ranging from 1 to 300 nm, for example ranging anywhere from 1 to 3 to 10 to 30 to 100 to 300 nm (i.e., ranging between any two of the preceding values).

In some embodiments, the modified surface includes a surface polymer, which may comprise functional groups that covalently or electrostatically bond to the hybrid organic-inorganic porous shell. Examples of functional groups that electrostatically bond to the hybrid organic-inorganic porous shell include amide functional groups and amine functional groups. In this regard, the hybrid organic-inorganic materials described herein are weakly acidic in nature and thus tend to be deprotenated and negatively charged, whereas the amide functional groups or amine functional groups described herein are basic in nature and thus tend to be protenated and positively charged. Examples of functional groups that covalently bond to the hybrid organic-inorganic porous shell include organosilane functional groups, organotitanium functional groups, and organozirconium functional groups, among others. As used herein, an organosilane functional group is a functional group having at least one Si—C bond. Similarly, an organotitanium functional group is a functional group having at least one Ti—C bond, and an organozirconium functional group is a functional group having at least one Zr—C bond.

In some embodiments, the modified surface includes a surface polymer, which may comprise monomer residues that covalently or electrostatically bond to the hybrid organic-inorganic porous shell. Examples of monomer residues that electrostatically bond to the hybrid organic-inorganic porous shell include amide monomer residues and amine monomer residues. Examples of monomer residues that are covalently bonded to the hybrid organic-inorganic porous shell include organosilane monomer residues, organotitanium monomer residues, and organozirconium monomer residues. As used herein, an organosilane monomer residue is a monomer residue having at least one Si—C bond, an organotitanium monomer residue is a monomer residue having at least one Ti—C bond, and an organozirconium monomer residue is a monomer residue having at least one Zr—C bond.

The surface polymer may, comprise, for example, polymer chains that are grafted on the non-porous polymer core.

The surface polymer may, comprise, for example, a crosslinked polymer network that is formed on the non-porous polymer particle core.

Surface polymers can be prepared via a number of processes and mechanisms including, but not limited to, chain addition and step condensation processes, radical, anionic, cationic, ring-opening, group transfer, metathesis, and photochemical mechanisms. In particularly beneficial embodiments, the porous organic polymer cores are prepared via free radical polymerization.

As noted above, polymer particle cores may contain surface moieties from which further polymerization can proceed. For example, organic polymer cores formed from free radical polymerization commonly contain residual radical-polymerizable unsaturated surface moieties (e.g., ethylenyl moieties, vinyl moieties, methacryloxy moieties, acryloxy moieties, etc.), from which polymerization of the surface polymer can proceed. Polymer chains can be from monofunctional monomers. Crosslinked polymer networks can be formed from multifunctional monomers. Monofunctional monomers may be included in addition to multifunctional monomers in such crosslinked polymer networks.

As noted above, surface polymers include those comprising amide monomer residues. Examples of amide monomer residues include amide monomer residues having the formula,

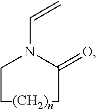

wherein n is an integer from 1-3 (i.e., N-vinyl pyrrolidone, N-vinyl-2-piperidinone or N-vinyl caprolactam). Examples of amide monomer residues also include amide monomer residues having the formula

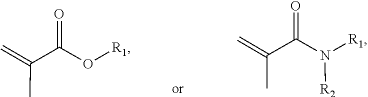

wherein R₁ is selected from C₁-C₆ alkylene, C₂-C₆ alkenylene, C₂-C₆ alkynylene, C₆-C₁₈ arylene groups, and wherein R₂ is selected from H, C₁-C₆ alkylene, C₂-C₆ alkenylene, C₂-C₆ alkynylene, C₆-C₁₈ arylene groups.

As also noted above, surface polymers include those comprising amine monomer residues. Examples of amine monomer residues include aminoalkyl acrylates, aminoalkyl methacrylates, dialkylaminoalkyl acrylates, or dialkylaminoalkyl methacrylates, including amino-C₁-C₄-alkyl acrylates, amino-C₁-C₄-alkyl methacrylates, di-C₁-C₄-alkylamino-C₁-C₄-alkyl acrylates, di-C₁-C₄-alkylamino-C₁-C₄-alkyl methacrylates, such as 2-aminoethyl acrylate, 2-aminoethyl methacrylate, 2-(N,N-dimethylamino)ethyl acrylate, 2-(N,N-dimethylamino)ethyl methacrylate, 2-(N,N-diethylamino)ethyl methacrylate, or 2-diisopropylaminoethyl methacrylate.

As further noted above, examples of surface polymers further include those comprising silane monomer residues that are electrostatically bonded to the porous hybrid organic-inorganic shell layer. In some embodiments, the surface polymers comprise residues of one or more radical polymerizable organosilane monomers.

Specific examples of radical polymerizable organosilane monomers include unsaturated organosilane monomers (e.g., unsaturated organoalkoxysilane monomers, unsaturated organochlorosilane monomers, etc.), such as alkenyl- or alkynyl-functionalized organosilane monomers (e.g., alkenyl- or alkynyl-functionalized organoalkoxysilane monomers, alkenyl- or alkynyl-functionalized organochlorosilane monomers, etc.). Particular alkenyl-functionalized organoalkoxysilane monomers including those with vinyl groups, methacryloxy groups, and acryloxy groups. Specific examples include 3-(trimethoxysilyl)propyl methacrylate (also so known as 3-methacryloxypropyltrimethoxysilane, or MAPTMOS), methacryloxypropyltriethoxysilane, methacryloxypropyltrichlorosilane, vinyltriethoxysilane (VTES), vinyltrimethoxysilane, N— (3-acryloxy-2-hydroxypropyl)-3-aminopropyltriethoxy silane, (3-acryloxypropyl)trimethoxysilane, O-(methacryloxyethyl)-N— (triethoxysilylpropyl)urethane, N-(3-methacryl oxy-2-hydroxypropyl)-3-aminopropyltriethoxysilane, methacryloxymethyltriethoxysilane, methacryloxymethyltrimethoxysilane, methacryloxypropylmethyldiethoxysilane, methacryloxypropylmethyldimethoxysilane, methacryloxypropyltris(methoxyethoxy)silane, or 3-(N-styrylmethyl-2-aminoethylamino)propyltrimethoxysilane hydrochloride, among others.

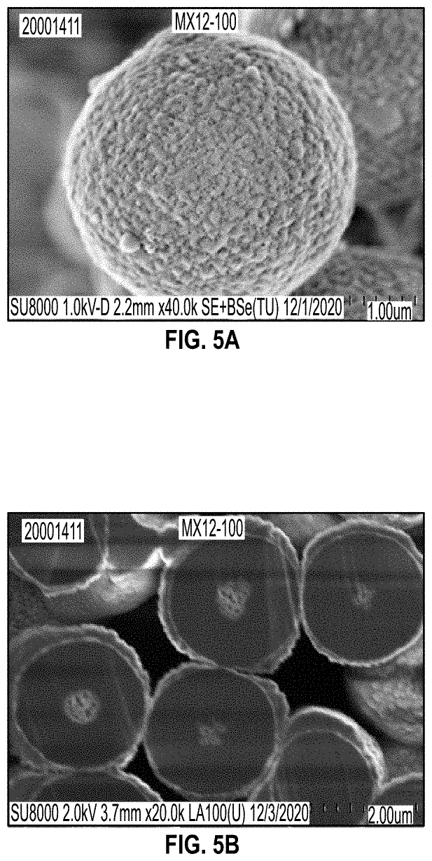

A particular embodiment of a process for forming a surface modified non-porous organic polymer core is shown in FIG. 3. In FIG. 3, an organosilane polymer, specifically, a poly(styryl-C₁-C₄-alkyl-tri-C₁-C₄-alkoxysilane), is formed by copolymerizing a styryl-C₁-C₄-alkyl-tri-C₁-C₄-alkoxysilane monomer where R in FIG. 3 is C₁-C₄ alkyl, with residual vinyl groups (e.g., residues of divinylbenzene) on a non-porous organic polymer core. Examples of styrene-based organosilane monomer include styrylethyltrimethoxysilane and styryltrimethoxysilane.

### Hybrid Organic-Inorganic Porous Shells.

As previously noted, the present disclosure pertains to core-shell particles in which a hybrid organic-inorganic porous shell is disposed on a surface modified non-porous organic polymer core.

The hybrid organic-inorganic porous shells (i.e., the porous hybrid organic-inorganic shell layer) have a pore volume that is greater than 0.1 cc/g of shell material, preferably greater than 0.65 cc/g of shell material. In various embodiments, the hybrid organic-inorganic porous shells have a pore volume that are substantially greater than 0.15 cc/g of shell material, for example, having a pore volume ranging from 0.2 to 1.5 cc/g of shell material, preferably ranging from 0.4 to 0.75 cc/g of shell material.

In some embodiments, the hybrid organic-inorganic porous shells may range, for example, from 0.1 to 4 microns in thickness, typically, from 0.1 to 2 microns in thickness, more typically, from 0.1 to 1.2 microns in thickness. In some embodiments, a ratio of the diameter of the cores to the diameter of the entire particles may range, for example, from 0.3:1 to 0.95:1, more typically, from 0.65:1 to 0.8:1.

In some embodiments, the hybrid organic-inorganic porous shells may have a pore size ranging from 20 Å or less to 2000 Å or more, for example, ranging anywhere from 20 to 50 to 100 to 200 to 500 to 1000 to 2000 Å.

An “organic-inorganic hybrid” material includes inorganic-based structures wherein an organic functionality is integral to both the internal or “skeletal” inorganic structure as well as the hybrid material surface. The inorganic portion of the hybrid material may be, e.g., silica, alumina, titanium, cerium, or zirconium or oxides thereof, or ceramic material. Exemplary hybrid materials are shown in U.S. Pat. Nos. 4,017,528, 6,528,167, 6,686,035, 7,175,913 and 7,919,177, the disclosures of which are hereby incorporated in their entirety.

In some embodiments, the hybrid organic-inorganic shell may comprise a silicon-based hybrid organic-inorganic material that comprises hybrid regions in which the material comprises silicon atoms having one or more silicon-oxygen bonds and one or more silicon-carbon bonds. In some cases the hybrid regions may comprise a substituted or unsubstituted alkylene, alkenylene, alkynylene or arylene moiety bridging two or more silicon atoms. For example the hybrid regions may comprise a substituted or unsubstituted C₁-C₁₈ alkylene, C₂-C₁₈ alkenylene, C₂-C₁₈ alkynylene or C₆-C₁₈ arylene moiety bridging two or more silicon atoms. In particular embodiments, the hybrid regions may comprise a substituted or unsubstituted C₁-C₆ alkylene moiety bridging two or more silicon atoms, including methylene, dimethylene or trimethylene moieties bridging two silicon atoms. In particular embodiments, the hybrid regions comprises may comprise ≡Si—(CH₂)ₙ Si≡ moieties, where n is an integer, and may be equal to 1, 2, 3, 4 or more. In some embodiments, the hybrid organic-inorganic shell may comprise a silicon-based hybrid organic-inorganic material that further comprises inorganic regions in which the material comprises silicon atoms having four silicon-oxygen bonds, in addition to hybrid regions in which the material comprises silicon atoms having one or more silicon-oxygen bonds and one or more silicon-carbon bonds.

In some embodiments, the porous hybrid organic-inorganic shell may comprise an organic-inorganic hybrid material of formula I:

(SiO₂)_{d}/[R²((R)ₚ(R¹)_{q}SiOₜ)ₘ] (I)

wherein,
R and R¹ are each independently C₁-C₁₈ alkoxy, C₁-C₁₈ alkyl, C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₅-C₁₈ aryloxy, or C₁-C₁₈ heteroaryl;
R² is C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₁-C₁₈ heteroaryl; or absent; wherein each R² is attached to two or more silicon atoms;
p and q are each independently 0.0 to 3.0;
tis 0.5, 1.0, or 1.5;
d is 0 to about 30;
m is an integer from 1-20; wherein R, R¹ and R² are optionally substituted;
provided that:
(1) when R² is absent, m=1 and

$$t = \frac{( 4 - ( p + q ) )}{2} ,$$

when 0<p+q≤3; and
(2) when R² is present, m=2-20 and

$$t = \frac{( 3 - ( p + q ) )}{2} ,$$

when p+q≤2.

In some embodiments, the hybrid organic-inorganic shell may comprise an organic-inorganic hybrid material of formula II:

(SiO₂)_{d}/[(R)ₚ(R¹)_{q}SiOₜ)ₘ] (II)

wherein,
R and R¹ are each independently C₁-C₁₈ alkoxy, C₁-C₁₈ alkyl, C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₅-C₁₈ aryloxy, or C₁-C₁₈ heteroaryl;
d is 0 to about 30;
p and q are each independently 0.0 to 3.0, provided that when p+q=1 then t=1.5; when p+q=2 then t=1; or when p+q=3 then t=0.5.

In some embodiments, the hybrid organic-inorganic shell may comprise an organic-inorganic hybrid material of formula III:

(SiO₂)_{d}[R²((R¹)ᵣSiOₜ)ₘ] (III)

wherein,
R¹ is C₁-C₁₈ alkoxy, C₁-C₁₈ alkyl, C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₅-C₁₈ aryloxy, or C₁-C₁₈ heteroaryl; R² is C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₁-C₁₈ heteroaryl; or absent; wherein each R² is attached to two or more silicon atoms;
d is 0 to about 30;
r is 0, 1 or 2, provided that when r=0 then t=1.5; or when r=1 then t=1; or when r=2 then t=0.5;
and
m is an integer from 1-20.

In some embodiments, the hybrid organic-inorganic shell may comprise an organic-inorganic hybrid material of formula IV:

(A)x(B)y(C)z (IV),

wherein the order of repeat units A, B, and C may be random, block, or a combination of random and block;
A is an organic repeat unit which is covalently bonded to one or more repeat units A or B via an organic bond;
B is an organosiloxane repeat unit which is bonded to one or more repeat units B or C via an inorganic siloxane bond and which may be further bonded to one or more repeat units A or B via an organic bond;
C is an inorganic repeat unit which is bonded to one or more repeat units B or C via an inorganic bond; and
x and y are positive numbers and z is a non-negative number, wherein x+y+z=1. In certain embodiments, when z=0, then 0.002≤x/y≤210, and when z≠0, then 0.0003≤y/z≤500 and 0.002≤x/(y+z)≤210.

In some embodiments, the hybrid organic-inorganic shell may comprise an organic-inorganic material of formula V:

(A)x(B)y(B*)y*(C)z (V),

wherein the order of repeat units A, B, B*, and C may be random, block, or a combination of random and block;
A is an organic repeat unit which is covalently bonded to one or more repeat units A or B via an organic bond;
B is an organosiloxane repeat units which is bonded to one or more repeat units B or B* or C via an inorganic siloxane bond and which may be further bonded to one or more repeat units A or B via an organic bond;
B* is an organosiloxane repeat unit which is bonded to one or more repeat units B or B* or C via an inorganic siloxane bond, wherein B* is an organosiloxane repeat unit that does not have reactive (i.e., polymerizable) organic components and may further have a protected functional group that may be deprotected after polymerization; C is an inorganic repeat unit which is bonded to one or more repeat units B or B* or C via an inorganic bond; and
x, y, and y* are positive numbers and z is a non-negative number, wherein x+y+z=1. In certain embodiments, when z=0, then 0.002≤x/(y+y*)≤210, and when z≠0, then 0.0003≤(y+y*)/z≤500 and 0.002≤x/(y+y*+z)≤210.

In various embodiments, hybrid organic-inorganic materials may be formed by hydrolytically condensing one or more organosilane compounds on surface modified non-porous organic polymer cores, such as those described above. As used herein, an organosilane compound is a silane compound having at least one Si—C bond.

The organosilane compounds may comprise, for example, (a) one or more organosilane compounds of the formula SiZ₁Z₂Z₃Z₄, where Z₁, Z₂, Z₃ and Z₄ are independently selected from C₁, Br, I, C₁-C₄ alkoxy, C₁-C₄ alkylamino, and C₁-C₄ alkyl, where at least one of Z₁, Z₂, Z₃ and Z₄ is C₁-C₄ alkyl, examples of which include alkyl-trialkoxysilanes such as C₁-C₄-alkyl-tri-C₁-C₄-alkoxysilanes, including methyl triethoxysilane, methyl trimethoxysilane, ethyl trimethoxysilane or ethyl triethoxysilane, and dialkyl-dialkoxysilanes, for example, C₁-C₄-dialkyl-di-C₁-C₄-alkoxysilanes, such as dimethyl diethoxysilane, dimethyl dimethoxysilane, diethyl dimethoxysilane or diethyl diethoxysilane, among many other possibilities and/or (b) one or more organosilane compounds of the formula ZiZ2Z₃Si—R—SiZ₄Z₅Z₆, where Z₁, Z₂ and Z₃ are independently selected from C₁, Br, I, C₁-C₄ alkoxy, C₁-C₄ alkylamino, and C₁-C₄ alkyl, although at most two of Z₁, Z₂ and Z₃ can be C₁-C₄ alkyl, where Z₄, Z₅ and Z₆ are independently selected from C₁, Br, I, C₁-C₄ alkoxy, C₁-C₄ alkylamino, and C₁-C₄ alkyl, although at most two of Z₄, Z₅ and Z₆ can be C₁-C₄ alkyl, and where R is an organic radical, for example, selected from C₁-C₁₈ alkylene, C₂-C₁₈ alkenylene, C₂-C₁₈ alkynylene or C₆-C₁₈ arylene groups, typically, C₁-C₄ alkylene, typically, C₁-C₆ alkylene. Examples of compounds of the formula ZiZ2Z₃Si— R—SiZ₄ZsZ6 include bis(trialkoxysilyl)alkanes, for instance, bis(tri-C₁-C₄-alkoxysilyl)C₁-C₄-alkanes such as bis(trimethoxysilyl)methane, bis(trimethoxysilyl)ethane, bis(triethoxysilyl)methane, and bis(triethoxysilyl)ethane, among many other possibilities.

In some embodiments, one or more additional non-organosilane compounds may be hydrolytically condensed along with the one or more organosilane compounds. Such compounds include silane compounds of the formula SiZ₁Z₂Z₃Z₄, where Z₁, Z₂, Z₃ and Z₄ are independently selected from C₁, Br, I, C₁-C₄ alkoxy and C₁-C₄ alkylamino. In certain embodiments the additional silane compounds are tetra-C₁-C₄-alkoxysilanes such as tetramethoxysilane or tetraethoxysilane.

In some embodiments, hybrid organic-inorganic materials may be formed by hydrolytically condensing the following on a surface modified non-porous organic polymer core as described above: (a) one or more alkyoxysilanes, for example, tetraalkoxysilanes (e.g., tetramethoxysilane (TMOS), tetraethoxysilane (TEOS), etc.) and (b) one or more organosilanes, for example, selected from bis(trialkoxysilyl)alkanes (e.g., bis(trimethoxysilyl)methane, bis(trimethoxysilyl)ethane, bis(triethoxysilyl)methane, bis(triethoxysilyl)ethane (B TEE), etc.) and/or alkyltrialkoxysilanes (e.g., methyl trimethoxysilane, methyl triethoxysilane (MTOS), ethyl triethoxysilane, etc.). Where the plurality of silane compounds comprise one or more bis(trialkoxysilyl)alkanes, alkyl-bridged hybrid organic-inorganic materials are prepared, which can offer various advantages over conventional silica-based materials, including chemical and mechanical stability. When BTEE is employed as a monomer, the resulting materials are ethylene bridged hybrid (BEH) materials. One particular BEH material can be formed from hydrolytic condensation of TEOS and B TEE.

In some embodiments, a plurality of silane compounds as described above, for example, a plurality of silane compounds comprising one or more organosilanes and one or more tetraalkoysilanes are partially condensed to form a polyalkoxyorganosiloxane oligomer, which is then hydrolytically condensed onto a surface modified non-porous organic polymer core. For example, BTEE and TEOS can be partially condensed to form a polyethoxyorganosiloxane oligomer (PEOS), which is hydrolytically condensed onto a surface modified non-porous organic polymer core.

In various embodiments, a hybrid organic-inorganic porous shell may be formed by creating (typically in a series of steps) a reaction mixture comprising the following components: surface modified non-porous organic polymer cores, ethanol, one or more porogens, one or more silanes including one or more organosilanes as previously described (e.g., TEOS and BTEE, or PEOS), water, and a basic or acidic catalyst to promote silane hydrolysis and condensation of hybrid organic-inorganic material on the surface modified non-porous organic polymer cores. In some embodiments, the hydrolysis proceeds at room temperature. In some embodiments, the mixture may be heated to drive the hydrolysis reaction to completion. In some embodiments, the mixture is agitated. After forming the hybrid organic-inorganic shell, the resulting particles may be washed and dried. In general, porosity is introduced through extraction, degradation, or evaporation of the porogen.

Examples of porogens include the following: water immiscible organic solvents such as toluene, non-ionic surfactants including aromatic polyoxyethylene surfactants such as Triton™ surfacants, polyoxyethylene-polyoxypropylene block copolymers such as Pluronic™ surfactants, and ionic surfactants such as cetyltrimethyl ammonium bromide (CTAB) and trioctylmethylammonium bromide (TMAB), polyphenolic compounds such tannic acid, and organic polymers such as polystyrene.

Examples of basic catalysts include hydroxide salts such as potassium hydroxide, sodium hydroxide or ammonium hydroxide, amines such as octylamine, N,N-Dimethylhexadecylamine, and dodecylamine).

In other embodiments, a hybrid organic-inorganic porous shell may be formed by interaction between a template surfactant (e.g., and ionic surfactant such as cetyltrimethyl ammonium bromide (CTAB) or trioctylmethylammonium bromide (TOMB)) and one or more silanes including one or more organosilanes as previously described (e.g., TEOS and BTEE, or PEOS) during continuous addition of silanes, basic catalyst and template surfactant to surface modified non-porous organic polymer cores. This process leads to continuous silane hydrolysis and condensation of hybrid organic-inorganic reaction product on the cores. The reaction may be conducted at room temperature or at elevated temperatures. A porous shell is formed upon subsequent removal of the template surfactant.

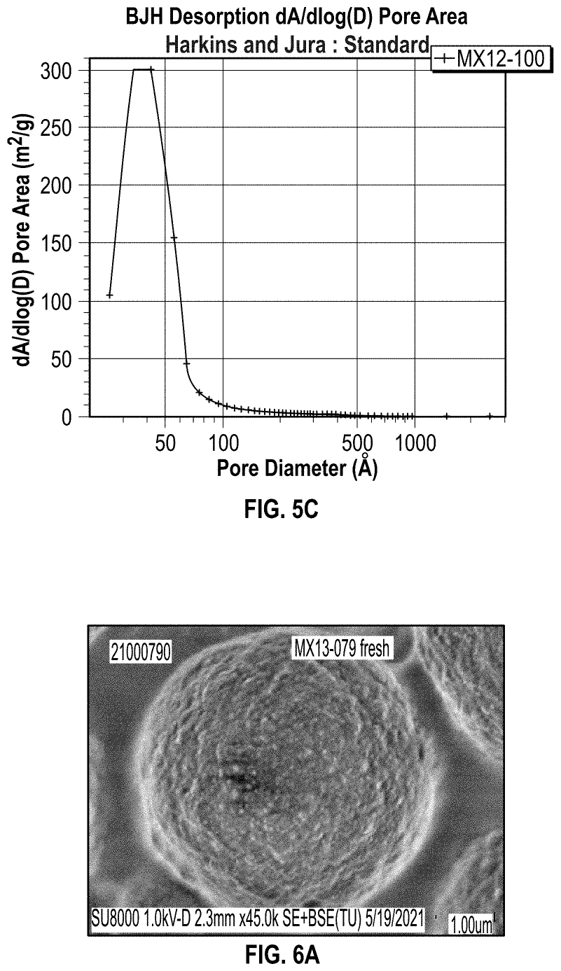

With reference now to FIG. 4A and FIG. 4B, one or more organosilanes as previously described (e.g., TEOS and BTEE, or PEOS) may be hydrolyzed in the presence of a porogen and a surface modified non-porous (NP) organic polymer core having a surface polymer that comprises monomer residues 405 of amide monomers and/or silane monomers such that the hydrolyzed organosilanes form a hybrid organic-inorganic layer on the core. Upon removal of the porogen, a hybrid organic-inorganic porous shell is formed.

Potential advantages of the core-shell particles of the present disclosure include improvements in mass transfer and increased efficiencies relative to fully porous particles, improved pH stability, and the ability to form an array of particle and pore sizes. The core-shell particles can be used as chromatography packing materials for the separation of both small molecules and large biologics.

### Shell Modification.

The hybrid organic-inorganic porous shell may be modified with a coating or by surface derivation. The coating and shell surface may be connected via or chemical bond or via Van der Waals forces. The coated or uncoated shell pore surface may be derivatized with desired functionality to meet a given separation requirement. Such surface modification may include but is not limited to modification with long chain (e.g., C₄ to C₂₀) alky groups, modification with polyethylene glycols, modification with hydrophilic polymers based on acrylamide and (meth)acrylate, and modification with polar groups containing nitride, nitrile, hydroxyl, and negatively and/or positively charged groups.

### Chromatographic Devices.

In some aspects of the present disclosure, the core-shell particles described herein may be provided in a suitable chromatographic device. For this purpose, the core-shell particles described herein may be provided in conjunction with a suitable housing. The core-shell particles and the housing may be supplied independently, or the core-shell particles may be pre-packaged in the housing. Housings for use in accordance with the present disclosure commonly include a chamber for accepting and holding core-shell particles. In various embodiments, the housings may be provided with an inlet and an outlet leading to and from the chamber.

Suitable construction materials for the chromatographic housings include inorganic materials, for instance, metals such as stainless steel and ceramics such as glass, as well as synthetic polymeric materials such as polyethylene, polypropylene, polyether ether ketone (PEEK), and polytetrafluoroethylene, among others.

In certain embodiments, the chromatographic housings may include one or more filters which act to hold the core-shell particles in a housing. Exemplary filters may be, for example, in a form of a membrane, screen, frit or spherical porous filter.

In certain embodiments, the chromatographic device is a chromatographic column.

The present disclosure also provides for a kit comprising the core-shell particles, housings or devices as described herein and instructions for use. In one embodiment, the instructions are for use with a separation device, e.g., a chromatographic column.

### Chromatographic Separations.

In some aspects of the present disclosure, the core-shell particles of the present disclosure can be used in a variety of chromatographic separation methods. As such, the chromatographic devices and chromatographic kits described herein can also be utilized for such methods. Examples of chromatographic separation methods in which the core-shell particles of the invention can be used include used in both high-pressure liquid chromatography (HPLC) and ultra-high pressure liquid chromatography (UPLC) in different modes. Those modes include, but are not limited to, affinity separation, hydrophilic interaction chromatography (HILIC) separations, normal-phase separations, reversed-phase separations, chiral separations, supercritical fluid chromatography SFC separations, perfusive separations, size-exclusion chromatography (SEC) separations, ion exchange separations, or multimode separations.

The core-shell particles, devices and kits of the present disclosure may be used for chromatographic separations of small molecules, carbohydrates, antibodies, whole proteins, peptides, and/or DNA, among other species.

Such chromatographic separations may comprise loading a sample onto core-shell particles in accordance with the present disclosure and eluting adsorbed species from the core-shell particles with a mobile phase.

Such chromatographic separations may be performed in conjunction with a variety of aqueous and/or organic mobile phases (i.e., in mobile phases that contain water, an organic solvent, or a combination of water and organic solvent) and in conjunction with a variety of mobile phase gradients, including solvent species gradients, temperature gradients, pH gradients, salt concentration gradients, or gradients of other parameters.

### Example 1. Polymer Particle Primed with Silane Containing Layer

The inhibitor in both divinylbenzene (80%, technical grade) and styryl ethyltrimethoxysilane were removed by passing through an alumina cartridge. The reagent alcohol used in the reaction contains 90% ethanol, ˜5% methanol and ˜5% isopropanol. In a typical particle synthesis experiment (Example 1A), 15.9 grams of PVP-40, 58.6 grams g of p-xylene were charged into a 1 L round bottom flask reactor equipped with mechanical agitation, condenser reactor and thermocouple. A slurry of 50.0 grams of 2.0 μm poly(DVB80) particle in 528.8 grams of reagent alcohol was added. The mixture was mixed at 200 RPM for 24 hours. Then the reaction slurry was purged with nitrogen via sub-surface to obtain a dissolved oxygen below 1 ppm. Once the dissolved oxygen in the solution is less than 1 ppm, the reaction mixture was heated to 70° C. and the agitation speed was adjusted to 75 RPM. Then, 2.5 grams of divinylbenzene and 0.9 grams of 2,2′-Azobis(2-methylpropionitrile) (AIBN) were added. After 15 minutes of mixing, a solution containing 12.7 grams of styryl ethyltrimethoxysilane, 1.3 grams of divinylbenzene and 3.0 grams of PVP-40 in 101.3 grams of reagent alcohol was added at a constant flow rate over 2 hours. After the reaction was held at 70° C. for a total of 20 hrs, cool the reaction to below 40° C. and the produced particles were separated from the reaction slurry by filtration. The particles were washed with methanol, followed with tetrahydrofuran (THF), and lastly with acetone. The final product was dried in vacuum oven at 45° C. overnight. 54 grams of coated particles were obtained.

Example 1A to Example 1H in the following table describe the synthesis of primed particles with different surface morphology and primer layer thickness by adjusting the amount of primer monomer use and the amount of crosslinker DVB80 use.

| | Core particle slurry formulation (g) | | | | | | Primer solution formulation (g) | | | |
|---|---|---|---|---|---|---|---|---|---|---|
| | | Reagent | | | | | | Styryl | | Reagent |
| Example | Core particle | alcohol | p-Xylene | PVP-40 | AIBN | DVB80 | DVB80 | ethyltrimethoxylsilane | PVP-40 | alcohol |
| 1A | 50.0 | 528.8 | 58.6 | 15.9 | 0.9 | 2.5 | 1.3 | 12.7 | 3.0 | 101.3 |
| 1B | 82.7 | 874.7 | 96.9 | 26.2 | 1.4 | 4.1 | 0.0 | 20.7 | 5.0 | 165.4 |
| 1C | 50.0 | 514.0 | 57.0 | 15.4 | 0.9 | 0.9 | 0.5 | 4.7 | 1.7 | 56.4 |
| 1D | 50.0 | 514.0 | 57.0 | 15.4 | 0.9 | 1.8 | 0.9 | 9.0 | 3.6 | 120.0 |
| 1E | 30.0 | 317.3 | 35.2 | 9.5 | 0.5 | 1.5 | 4.8 | 21.0 | 8.7 | 288.6 |
| 1F | 14.0 | 308.0 | 34.1 | 9.2 | 1.0 | 0.7 | 6.6 | 24.4 | 12.5 | 406.7 |
| 1G | 17.5 | 385.0 | 40.6 | 11.6 | 1.0 | 0.9 | 5.1 | 19.8 | 8.8 | 291.7 |
| 1H | 22.0 | 493.9 | 39.4 | 14.8 | 1.0 | 1.1 | 3.5 | 15.4 | 4.9 | 163.9 |

### Example 2. Polymer Particle Primed with Poly(Vinyl Pyrrolidone) Layer

The inhibitor in divinylbenzene (80%, technical grade) was removed by passing through an alumina cartridge and N-vinyl pyrrolidone was used as supplied. The reagent alcohol used in the reaction contains 90% ethanol, ˜5% methanol and ˜5% isopropanol. 15.4 grams of PVP-40, 57.0 grams g of p-xylene were charged into a 1 L round bottom flask reactor equipped with mechanical agitation, condenser and thermocouple. A slurry of 50.0 grams of 2.0 poly(DVB80) particle in 514 grams of reagent alcohol was added. The mixture was mixed at 200 RPM for 24 hours. Then the reaction slurry was purged with nitrogen via sub-surface to obtain a dissolved oxygen below 1 ppm. Once the dissolved oxygen in the solution is less than 1 ppm, the reaction mixture was heated to 70° C. and the agitation speed was adjusted to 75 RPM. Then, 1.8 grams of divinylbenzene and 0.9 grams of 2,2′-Azobis(2-methylpropionitrile) (AIBN) were added. After 15 minutes of mixing, a solution containing 9.0 grams of N-vinyl pyrrolidone, 0.9 grams of divinylbenzene and 3.6 grams of PVP-40 in 120.0 grams of reagent alcohol was added at a constant flow rate over 72 minutes. Then the reaction was held at 70° C. for a total of 20 hrs. After completion of the reaction, the produced particles were separated from the reaction slurry by filtration. The particles were washed with methanol, followed with tetrahydrofuran (THF), and lastly with acetone. The final product was dried in vacuum oven at 45° C. overnight. 52 grams of coated particles were obtained.

### Example 3. Hybrid Coating on Silane Primed Particle Surface

Non-porous, silica-primed polymer particles were surface modified with an organic/inorganic hybrid surrounding material as described in PCT Patent No. WO 2017/155870 to yield polymeric core particles having an organic/inorganic surface. In this instance, the partial hydrolytic condensed product of a 4:1 mixture of tetraethyl orthosilicate (TEOS) and 1,2-Bis(triethoxysilyl)ethane (BTEE) was used to modify the surface of the particles. In a typical reaction, 6.0 grams of silane primed polymer particles from Example 1 were dispersed in 122.2 grams of toluene and the dispersion was charged into a 250 mL round bottom flask reactor equipped with mechanical agitation, condenser with DS trap (35 mL trap volume) and thermocouple. The reaction was refluxed at 114° C. for one hour. After one hour reflux, cool the reaction to 40° C. and maintain the trapped toluene in the DS trap. Then, 4.93 grams of PEOS was added to the reaction followed by addition of 0.3 grams of ammonium hydroxide. The reaction temperature was raised to 60° C. and maintained at 60° C. for 2.5 hours. After 2.5 hours hold, cool reaction to less than 40° C. and the particle were isolated by filtration and further washed with ethanol for two times. The particles were then transferred back to a 250 mL round bottom flask, 36.0 grams of milli-Q water, 18.9 grams of ethanol and 6.0 grams of ammonium hydroxide were added. The reaction temperature was raised to 50° C. and held at 50° C. for 2 hours. After completion of the reaction, the particles were isolated from the reaction slurry by filtration. The particles were washed with a mixture of methanol/water, followed by methanol. The final product was dried in vacuum oven at 45° C. overnight.

### Example 4. Porous Hybrid Shell Synthesis by Using KOH as Catalyst

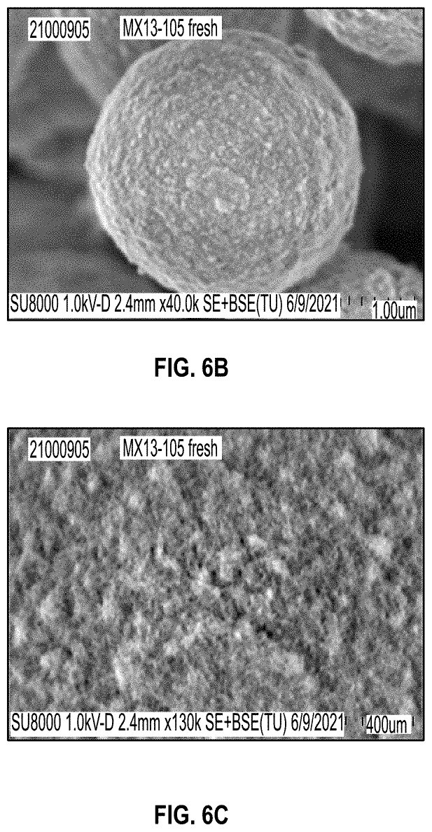

3.0 grams of hybrid coated particle made in Example 3 was dispersed in 87.4 grams of ethanol and the slurry was charged to a 250 ml round-bottom flask equipped with mechanical agitation. Subsequently, 5.24 grams of triton X-100 and 87.4 grams of toluene were added into the flask. Adjust the agitation speed to 150 RMP and 6.4 grams of 45% potassium hydroxide aqueous solution was added. After the reaction mixture was mixed at room temperature for 40 minutes, a mixture of 8.0 grams of tetraethyl orthosilicate (TEOS) and 2.0 grams of 1,2-Bis(triethoxysilyl)ethane (BTEE) was charged. The reaction was allowed to proceed at room temperature for 24 hours. After reaction, the particles were separated from the reaction slurry by filtration. The particles were washed for three times with methanol and deionized water, respectively. The particle was finally washed with methanol for another three times and then were dried in vacuum oven at 45° C. overnight. FIG. 5A is an electron micrograph of the whole particles. FIG. 5B is an electron micrograph of the particle cross-sections. Pore area vs. pore diameter are shown in FIG. 5C.

### Example 5. Porous Hybrid Shell Synthesis by Using Octylamine as Catalyst

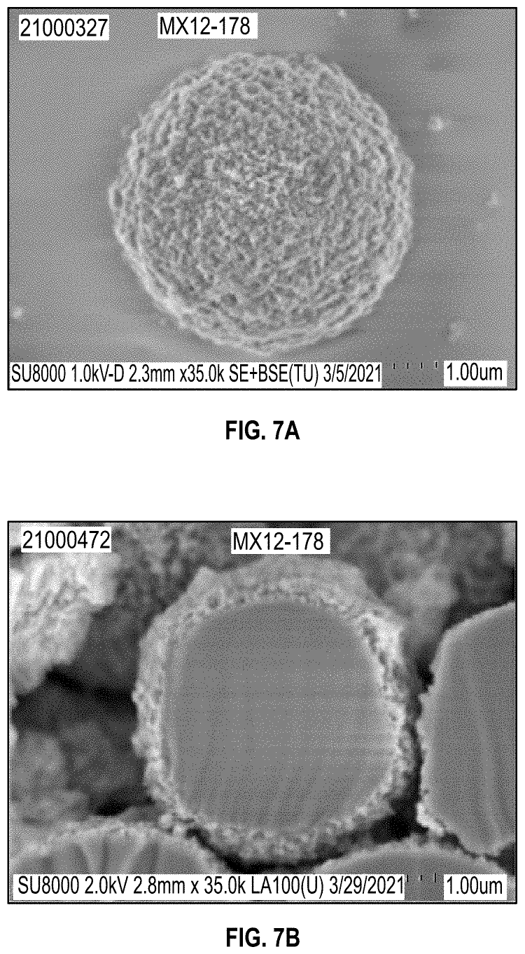

3.0 grams of silane primed particle (Example 1C) was dispersed in 150 grams of ethanol and the slurry was charged to a 250 ml round-bottom flask equipped with mechanical agitation, condenser and thermocouple. FIG. 6A is an electron micrograph of the whole silane primed particle. Subsequently, 4.8 grams of Pluronic P103, 23.6 grams of Milli-Q water and 6.4 grams of octylamine were added. After the reaction mixture was mixed at room temperature for 40 minutes, a mixture of 7.2 grams of tetraethyl orthosilicate (TEOS) and 1.8 grams of 1,2-Bis(triethoxysilyl)ethane (BTEE) was charged. The reaction temperature was raised to 50° C. and hold the reaction at 50° C. for 24 hours. After reaction, the particles were separated from the reaction slurry by filtration. The particles were washed for three times with methanol and deionized water, respectively. The particle was finally washed with methanol for another three times and then were dried in vacuum oven at 45° C. overnight. FIG. 6B is an electron micrograph of the whole particles. FIG. 6C is an electron micrograph of the particle surface.

### Example 6. Porous Hybrid Shell Synthesis by Using Ammonium Hydroxide Catalyst

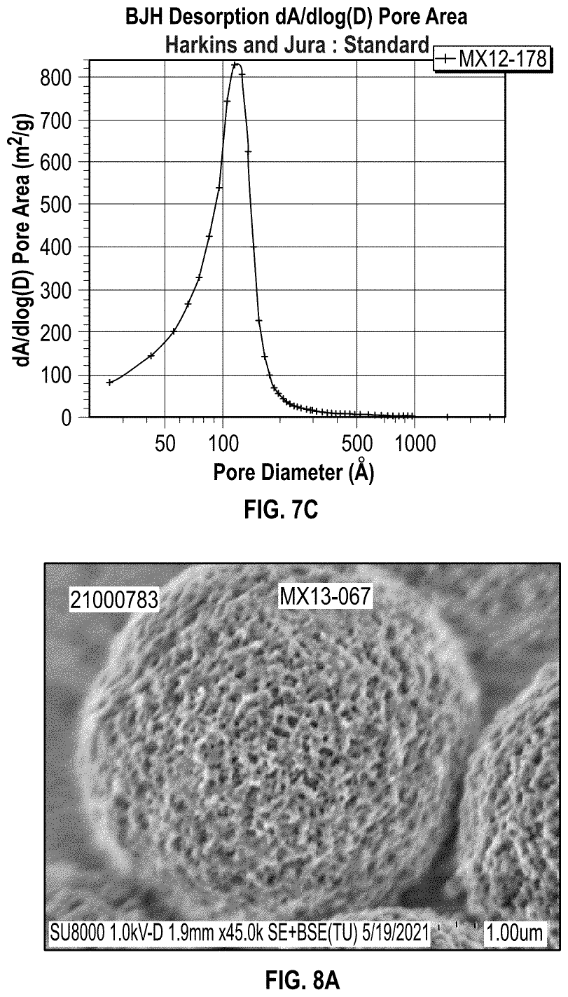

2.5 grams of silane primed particle was dispersed in 72.8 grams of ethanol and the slurry was charged to a 250 ml round-bottom flask equipped with mechanical agitation. Subsequently, 3.64 grams of Triton X-100, 72.8 grams of toluene and 5.3 grams of ammonium hydroxide were added. After the reaction slurry was mixed at room temperature for 40 minutes, a mixture of 3.0 grams of PEOS, 2.4 grams of tetraethyl orthosilicate (TEOS) and 0.6 grams of 1,2-Bis(triethoxysilyl)ethane (BTEE) was charged. The reaction was proceeded at room temperature for 24 hours. After reaction, the particles were separated from the reaction slurry by filtration. The particles were washed for three times with methanol and deionized water, respectively. The particle was finally washed with methanol for another three times and then were dried in vacuum oven at 45° C. overnight. FIG. 7A is an electron micrograph of the whole particle. FIG. 7B is an electron micrograph of the particle cross-section. Pore area vs. pore diameter are shown in FIG. 7C.

### Example 7. Porous Hybrid Shell Synthesis by Using Emulsified PEOS

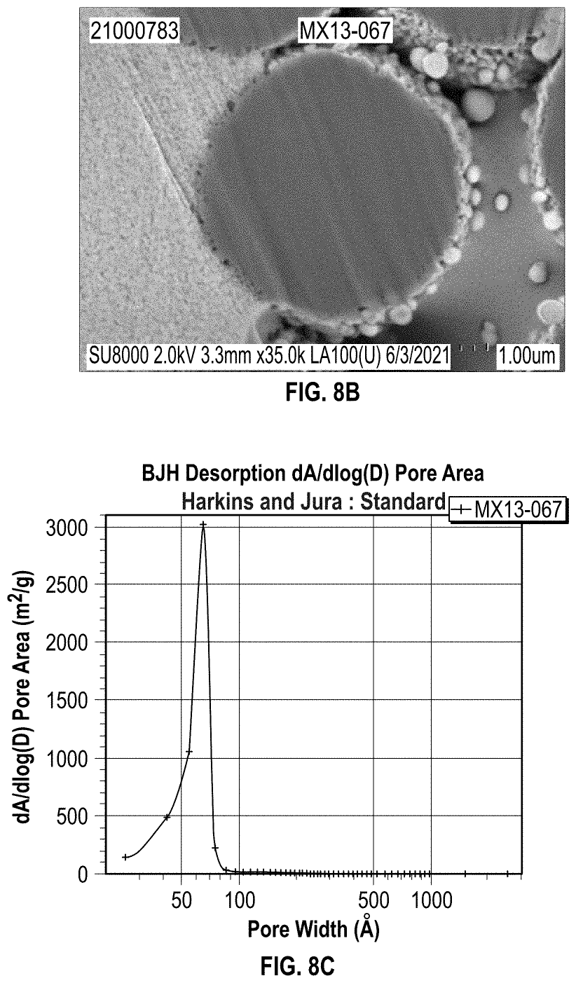

4.5 grams of silane primed particle was dispersed in 80 grams of 0.2% Triton X-100 solution in water/ethanol (82/18, wt/wt). The slurry was charged to a 250 ml round-bottom flask equipped with mechanical agitation, condenser and thermocouple. Then, into the flask was charged an emulsion of 9.0 grams of PEOS and 3.2 grams of toluene in 47.5 grams of 0.2% Triton X-100 in water/ethanol (82/18, wt/wt). The reaction mixture was agitated at 150 RMP at room temperature for 24 hours. The reaction was proceeded by adding 4.7 grams of ammonium hydroxide at 50° C. for 20 hours. After reaction, the particles were separated from the reaction slurry by filtration. The particles were washed for three times with methanol and deionized water, respectively. The particle was finally washed with methanol for another three times and then were dried in vacuum oven at 45° C. overnight. FIG. 8A is an electron micrograph of the whole particle. FIG. 8B is an electron micrograph of the particle cross-sections. Pore area vs. pore diameter are shown in FIG. 8C.

### Example 8. Porous Hybrid Shell Synthesis by Using Emulsified PEOS

4.5 grams of silane primed particle was dispersed in 130 grams of 10% Triton X-100 solution in water/ethanol (87/13, wt/wt). The slurry was charged to a 250 ml round-bottom flask equipped with mechanical agitation, condenser and thermocouple. Then, into the flask was charged an emulsion of 9.0 grams of PEOS and 4.5 grams of toluene in 47.5 grams of 10% Triton X-100 in water/ethanol (87/13, wt/wt). The reaction mixture was agitated at 150 RMP at room temperature for 24 hours. The reaction was proceeded by adding 7.0 grams of ammonium hydroxide at 50° C. for 20 hours. After reaction, the particles were separated from the reaction slurry by filtration. The particles were washed for three times with methanol and deionized water, respectively. The particle was finally washed with methanol for another three times and then were dried in vacuum oven at 45° C. overnight.

### Example 9. Porous Hybrid Shell Synthesis by Using Tannic Acid as Porogen

3.0 grams of silane primed particle was dispersed in 174.9 grams of ethanol and the slurry was charged to a 250 ml round-bottom flask equipped with mechanical agitation, condenser and thermocouple. Then, into the flask was charged 1.22 grams of tannic acid and 7.7 grams of ammonium hydroxide. After the reaction mixture was agitated at 150 RMP for 40 minutes, a mixture of 8.0 grams of tetraethyl orthosilicate (TEOS) and 2.0 grams of 1,2-Bis(triethoxysilyl)ethane (BTEE) was charged. The reaction was proceeded by adding 7.0 grams of ammonium hydroxide at 50° C. for 20 hours. After reaction, the particles were separated from the reaction slurry by filtration. The particles were washed for three times with methanol and deionized water, respectively. The particle was finally washed with methanol for another three times and then were dried in vacuum oven at 45° C. overnight.

### Example 10. Porous Hybrid Shell Synthesis by CTAB Directed Growth

3.15 grams of silane primed particles were weighed into glass Beaker A, slurried in 66 ml of 2/1, v/v, Milli-Q water/reagent ethanol, and further dispersed by stirring in a Branson 8510 ultrasonic bath for 10 minutes. In a second beaker, Beaker B, a solution of Cetyltrimethylammonium bromide (CTAB) was prepared by dissolving 1.4 grams of CTAB in 66 ml of 2/1, v/v, Milli-Q water/reagent ethanol to yield a clear solution. The CTAB solution in Beaker B was then added to the particle slurry in Beaker A and stirred in a Branson 8510 ultrasonic bath for 10 minutes. In a third beaker, Beaker C, a solution of Triton X-405 was prepared by dissolving 15.1 grams of Triton X-405 in 118 ml of 2/1, v/v, Milli-Q water/reagent ethanol to yield a clear solution. The Triton X-405 solution in Beaker C was then added to the particle slurry in Beaker A and stirred in a Branson 8510 ultrasonic bath for 10 minutes. The slurry was transferred to a 1-liter polypropylene centrifuge bottle with a magnetic stir bar (5 cm) and 16 ml of Ammonium Hydroxide. The centrifuge bottle was sealed, immersed in a 35° C. thermostatic bath, and magnetically stirred at 120 rpm while waiting for the metered and continuous introduction of silane and hydrolysis solutions by independent peristaltic pumps. The silane solution was prepared in a clean, dry, pear shaped flask by dissolving of 8.1 grams of tetraethyl orthosilicate (TEOS) and 3.4 grams of 1,2-Bis(triethoxysilyl)ethane (BTEE) in 28.9 grams of anhydrous reagent ethanol. The hydrolysis solution was prepared by dissolving 3.26 grams of CTAB, 6.0 grams of Triton X-405 and 16.2 grams of ammonium hydroxide in 190 ml of 2/1, v/v, Milli-Q water/reagent ethanol to yield a clear solution in a second pear shaped flask. Independent peristaltic pumps were used to add the silane and hydrolysis solutions to the reactor at flow rates of 40 and 176 uL/min respectively. Steps were taken by those known skilled in the art to keep the silane solution dry and minimize ammonia gas from escape from the reactor and hydrolysis solution reservoir. Addition continued until the silane solution was consumed. After silane addition was complete, the mixture was held and stirred at 35° C. for an additional 2.5 hours. 38 grams of ammonium hydroxide and 8.2 grams of Triton X-405 were added to the reactor and stirred for 15 min at 35° C. The mixture was then transferred to a 1-L 3-neck flask fitted with mechanical agitation and a water cooled condenser and heated to 78° C. for 7 hours then cooled overnight. The particles were recovered by filtration and washed twice with 250 ml aliquots of the following solvents; (2/1, v/v, Milli-Q water/reagent ethanol), (2/1, v/v, Milli-Q water/HPLC methanol), and (100% HPLC Acetone). Unwanted residual CTAB was removed from the particles by three consecutive overnight extractions in 90/10, v/v, acetone/2N HCl. After CTAB extractions, the particles were recovered by filtration and washed twice with 250 ml aliquots of the following solvents; (100% HPLC Acetone), (Milli-Q water), (HPLC methanol), and (100% HPLC Acetone). The final acetone-wet particles vacuum dried at 80° C. overnight.

### Example 11. Porous Hybrid Shell Synthesis Using Ammonium Hydroxide Catalyst

3.0 grams of silane primed particle with a particle size of 3.8 μm was dispersed in 142.8 grams of ethanol and the slurry was charged to a 250 ml round-bottom flask equipped with mechanical agitation, condenser and thermocouple. Subsequently, 3.9 grams of CTAB, 2.4 grams of Pluronic P123, 1.3 grams of Trioctylmethylammonium bromide, 32 grams of Milli-Q water and 3.2 grams of ammonium hydroxide (28-30%) were added. After the reaction mixture was mixed at room temperature for 60 minutes, a mixture of 13.68 grams of tetraethyl orthosilicate (TEOS) and 5.82 grams of 1,2-Bis(triethoxysilyl)ethane (BTEE) was charged. The mixture mas mixed at ambient temperature for 24 hours. After reaction, the particles were separated from the reaction slurry by filtration. The particles were washed for three times with methanol and deionized water, respectively. The particle was finally washed with methanol for another three times and then were dried in vacuum oven at 45° C. overnight. 8.2 grams of core shell particle was obtained. The final particle has a particle size of 5.2 μm.

### Example 12. Porous Hybrid Shell Synthesis Using N,N-Dimethylhexadecylamine as Catalyst

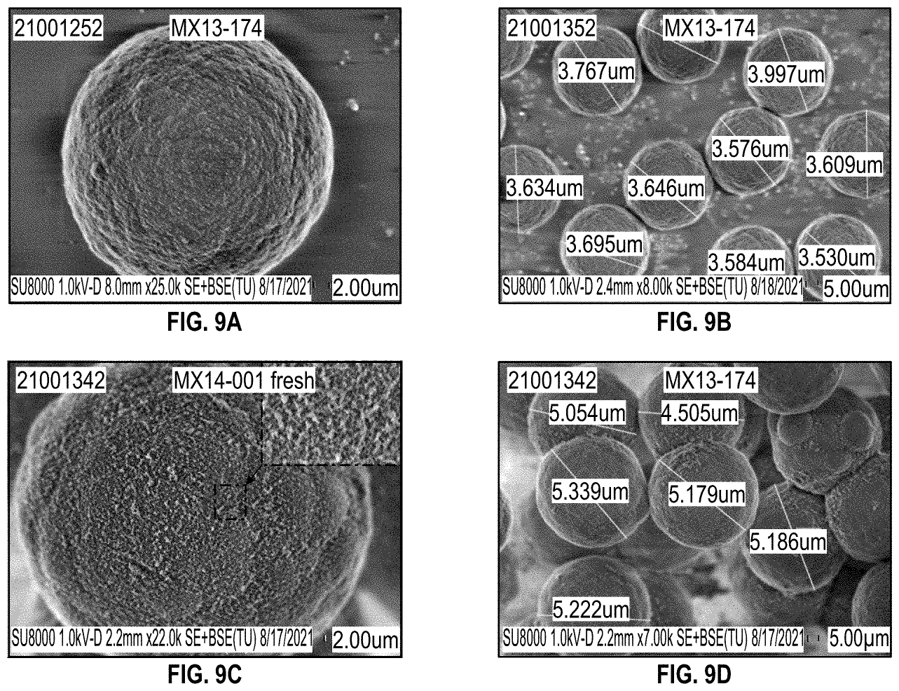

3.0 grams of silane primed particle with a particle size of 3.8 μm was dispersed in 117.6 grams of ethanol and the slurry was charged to a 250 ml round-bottom flask equipped with mechanical agitation, condenser and thermocouple. Subsequently, 6.5 grams of CTAB, 2.4 grams of Pluronic P123, 63.9 grams of Milli-Q water and 7.0 grams of N,N-Dimethylhexadecylamine were added. After the reaction mixture was mixed at room temperature for 60 minutes, a mixture of 13.68 grams of tetraethyl orthosilicate (TEOS) and 5.82 grams of 1,2-Bis(triethoxysilyl)ethane (BTEE) was charged. The mixture mas mixed at ambient temperature for 24 hours. After reaction, the particles were separated from the reaction slurry by filtration. The particles were washed for three times with methanol and deionized water, respectively. The particle was finally washed with methanol for another three times and then were dried in vacuum oven at 45° C. overnight. 8.0 grams of core shell particle was obtained. The final particle has a particle size of 5.2 FIG. 9A is an electron micrograph of the 3.8 core with silane layer. FIG. 9B is an electron micrograph of a plurality of particles (prior to formation of the shells). FIG. 9C is an electron micrograph of the 5.2 μm core shell particle. FIG. 9D is an electron micrograph of a plurality of core-shell particles of FIG. 9C.

### Example 13. Porous Hybrid Shell Synthesis Using Metered Delivery and Hydrothermal Processing Treatments

A 500 ml round bottom flask equipped with mechanical agitation, condenser and thermocouple was placed in a sonication bath with heating control (490 watts). To the reactor, added a dispersed slurry of 4.0 grams of surface modified particle (example 1A, particle size 2.0 μm) in 156.9 grams of ethanol, 70.9 grams of milli-Q water with 6.4 grams of Pluronic P123. Subsequently, 10.7 grams of N,N-Dimethylhexadecylamine was added. The reaction temperature was raised to 46° C. and the agitation speed was adjusted to 150 RPM. 14.03 grams of tetraethyl orthosilicate (TEOS) and 5.97 grams of 1,2-Bis(triethoxysilyl)ethane (BTEE) was emulsified in 47.1 grams of ethanol and 51.9 grams of Milli-Q water with 2.44 grams of Pluronic P123 as a surfactant. After the reaction slurry was mixed at 46° C. for 60 minutes, the emulsion was charged to the reaction via a pump at a constant flow rate over 6 hours. The reaction was held at 46° C. for 24 hours. After reaction, the particles were isolated by filtration and washed with methanol for three times. The particles were further aged at 55° C. for 24 hours in a solution containing 135.0 grams of ethanol, 122.0 grams of water and 30.0 grams ammonium hydroxide (28-30%, wt). The aged particles were isolated by filtration and washed with methanol, water, methanol, respectively. The particles were then dried in vacuum oven at 45° C. overnight, 8.9 grams of 3.2 μm aged core shell particles were obtained. The particles were hydrothermally autoclaved in a pH9.8 buffer at 155° C. for 20 hours. The particle was finally washed with methanol for three times and then were dried in vacuum oven at 45° C. overnight. The obtained particle superficially porous particle has a pore volume of 0.32 cc/g and an average pore size of 145 Å.

1. (canceled)

2. A core-shell particle comprising:
a non-porous polymer particle core having a modified surface; and
a porous hybrid organic-inorganic shell layer in contact with the modified surface of the non-porous polymer particle core; the modified surface being covalently or electrostatically bonded to the porous hybrid organic-inorganic shell layer.

3. The core-shell particle of claim 2, wherein the core-shell particle has a particle size ranging from 1 μm to 14 μm.

4. The core-shell particle of claim 2, wherein the non-porous polymer particle core comprises an organic polymer having a polymer backbone that contains C—C covalent bonds, C—O covalent bonds, C—N covalent bonds, O—N covalent bonds, or a combination thereof.

5. The core-shell particle of claim 2, wherein the non-porous polymer particle core comprises an organic polymer having a polymer backbone that contains C—C covalent bonds.

6. (canceled)

7. The core-shell particle of claim 2, wherein the non-porous polymer particle core comprises an organic polymer that comprises hydrophobic organic monomer residues, hydrophilic organic monomer residues, or a mixture of hydrophilic organic monomer residues and hydrophobic organic monomer residues.

8. The core-shell particle of claim 2, wherein the non-porous polymer particle core comprises polyfunctional monomer residues.

9. The core-shell particle of claim 2, wherein the non-porous polymer particle core comprises polyfunctional monomer residues and monofunctional monomer residues.

10. The core-shell particle of claim 9, wherein the non-porous polymer particle core comprises a central core region and an outer core region surrounding the central core region, and wherein a concentration of the monofunctional monomer residues is greater in the central core region than in the outer core region.

11. (canceled)

12. The core-shell particle of claim 2, wherein the non-porous polymer particle core comprises divinyl benzene residues, styrene residues, acrylate residues, methacrylate residues, acrylonitrile residues, acrylamide residues, and combinations thereof.

13. The core-shell particle of claim 2, wherein the modified surface of the non-porous polymer particle core comprises a crosslinked polymer layer.

14. The core-shell particle of claim 2, wherein the modified surface of the non-porous polymer particle core comprises polymer chains that are grafted on the non-porous polymer core.

15. The core-shell particle of claim 2, wherein the modified surface of the non-porous polymer particle core comprises a monomer residue that is covalently bonded to the porous hybrid organic-inorganic shell layer.

16. The core-shell particle of any of claim 15, wherein the monomer residue comprises an organosilane monomer residue, an organotitanium monomer residue, or an organozirconium monomer residue.

17. The core-shell particle of claim 2, wherein the modified surface of the non-porous polymer particle core comprises a monomer residue that is electrostatically bonded to the porous hybrid organic-inorganic shell layer.

18. The core-shell particle of claim 17, wherein the monomer residue comprises an amide monomer residue or an amine monomer residue.

19. The core-shell particle of claim 2, wherein the modified surface of the non-porous polymer particle core has a thickness that ranges from 1 to 300 nm.

20. (canceled)

21. (canceled)

22. (canceled)

23. The core-shell particle of claim 2, wherein the porous hybrid organic-inorganic shell layer has a pore size ranging from 20 Å to 2000 Å.

24. The core-shell particle of claim 2, wherein the porous hybrid organic-inorganic shell layer ranges 0.1 to 4 microns in thickness.

25. (canceled)

26. (canceled)

27. The core-shell particle of claim 2, wherein the porous hybrid organic-inorganic shell layer comprises a network of (a) silicon atoms having four silicon-oxygen bonds and (b) silicon atoms having one or more silicon-oxygen bonds and one or more silicon-carbon bonds.

28. The core-shell particle of claim 2, wherein the porous hybrid organic-inorganic shell layer comprises a substituted or unsubstituted C₁-C₄ alkylene, C₁-C₄ alkenylene, C₁-C₄ alkynylene or C₁-C₄ arylene moiety bridging two or more silicon atoms.

29. (canceled)

30. (canceled)

31. (canceled)

32. (canceled)
